(19) United States
(12) Patent Application Publication
(10) Pub. No.: US 2022/0306379 A1
(43) Pub. Date: Sep. 29, 2022

(54) Garbage Receptacle Assembly

(71) Applicant: Nicola Smith, Stockbridge, GA (US)

(72) Inventor: Nicola Smith, Stockbridge, GA (US)

(21) Appl. No.: 17/210,606

(22) Filed: Mar. 24, 2021

(51) Int. Cl. B65F 1/06; B65F 1/14

(52) U.S. Cl. CPC B65F 1/068; B65F 1/1473; B65F 2210/148

(57) ABSTRACT

A garbage receptacle assembly includes a garbage can that has an open top end for having a garbage bag positioned therein. The garbage can has a front entry integrated therein to facilitate the garbage bag to be removed through the front entry without requiring the garbage bag to be lifted out of the garbage can. A door is hingedly coupled to the garbage can to close the front entry when the door is in a closed position. A plurality of clips is each integrated into the garbage can. The garbage bag can be suspended from the clips for retaining the garbage bag in an open position to enhance placing garbage in the garbage bag.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to garbage devices and more particularly pertains to a new garbage device for facilitating a garbage bag to be removed through a front entry in a garbage can.

### (2) Description of Related Art Including Information Disclosed Under 37 CFR 1.97 and 1.98

The prior art relates to garbage devices including a variety of garbage cans that have an open front side for removing a garbage bag from the open front side. In each case the garbage can includes a front door and a top lid. In at least one instance a suspension is included for retaining a garbage bag in an open position.

### BRIEF SUMMARY OF THE INVENTION

An embodiment of the disclosure meets the needs presented above by generally comprising a garbage can that has an open top end for having a garbage bag positioned therein. The garbage can has a front entry integrated therein to facilitate the garbage bag to be removed through the front entry without requiring the garbage bag to be lifted out of the garbage can. A door is hingedly coupled to the garbage can to close the front entry when the door is in a closed position. A plurality of clips is each integrated into the garbage can. The garbage bag can be suspended from the clips for retaining the garbage bag in an open position to enhance placing garbage in the garbage bag.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a garbage receptacle assembly according to an embodiment of the disclosure.

FIG. 2 is a front perspective view of an embodiment of the disclosure showing a door in an open position.

FIG. 3 is a right side view of an embodiment of the disclosure.

FIG. 4 is a right side view of an embodiment of the disclosure showing a door in an open position.

FIG. 5 is a top view of an embodiment of the disclosure.

FIG. 6 is a bottom view of an embodiment of the disclosure.

FIG. 7 is a detail view of a clip of an embodiment of the disclosure.

FIG. 8 is a perspective in-use view of an embodiment of the disclosure.

### DETAILED DESCRIPTION OF THE INVENTION

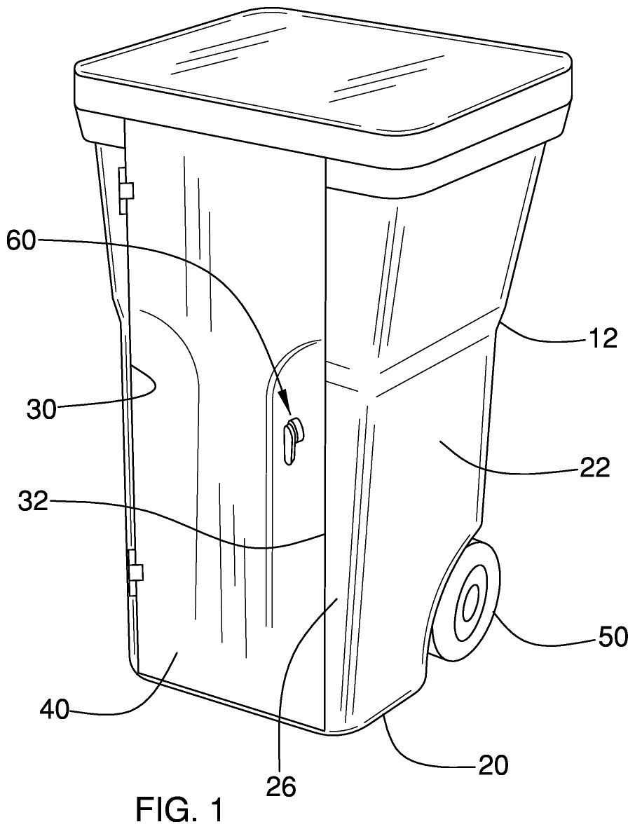

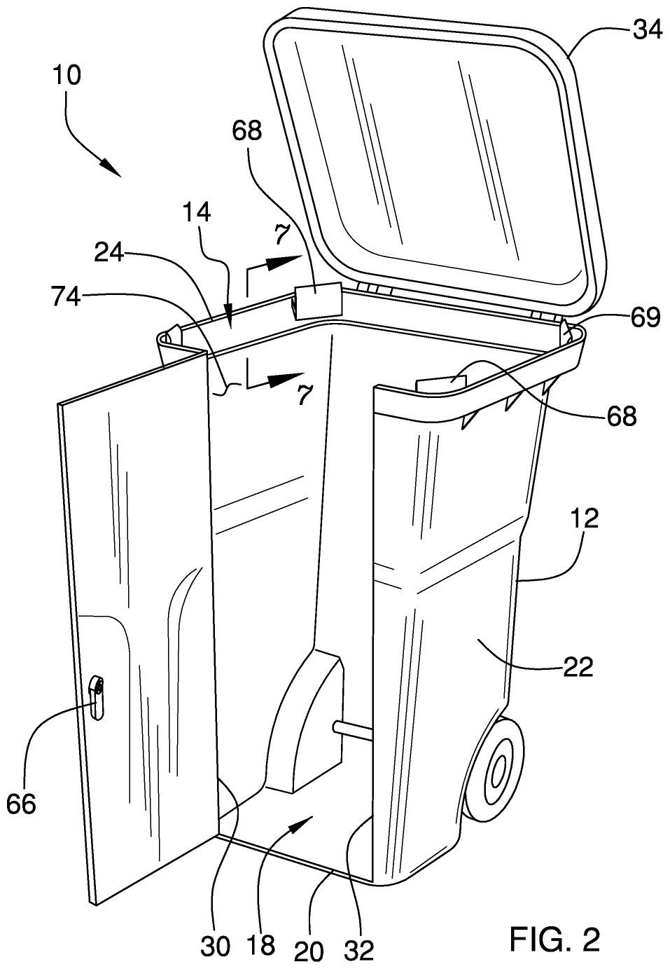

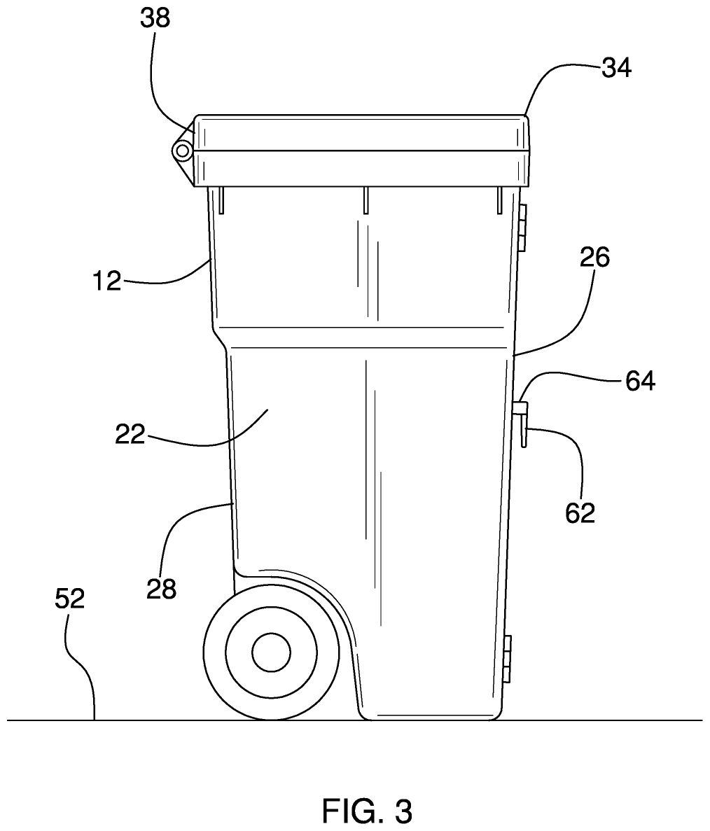

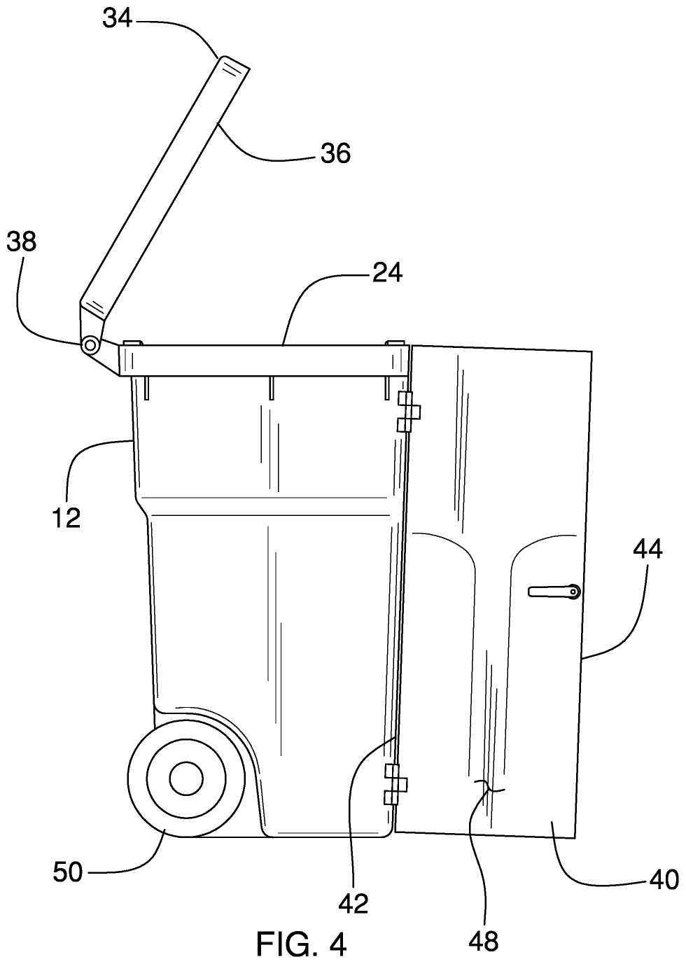

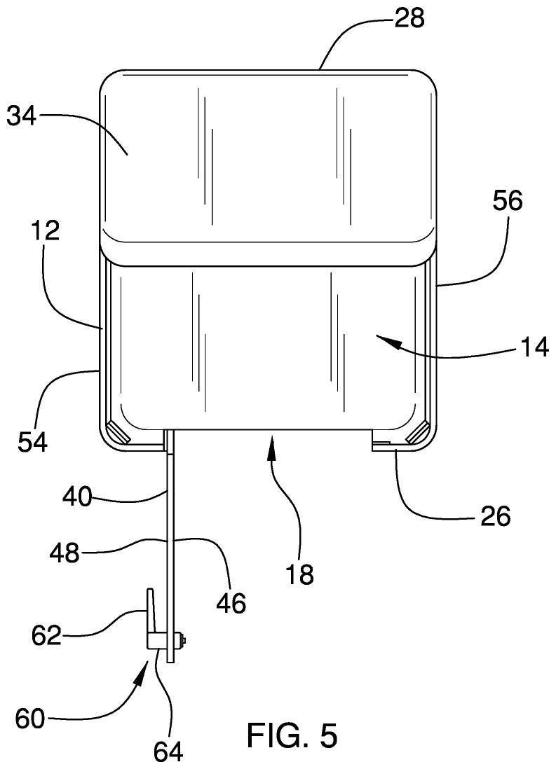

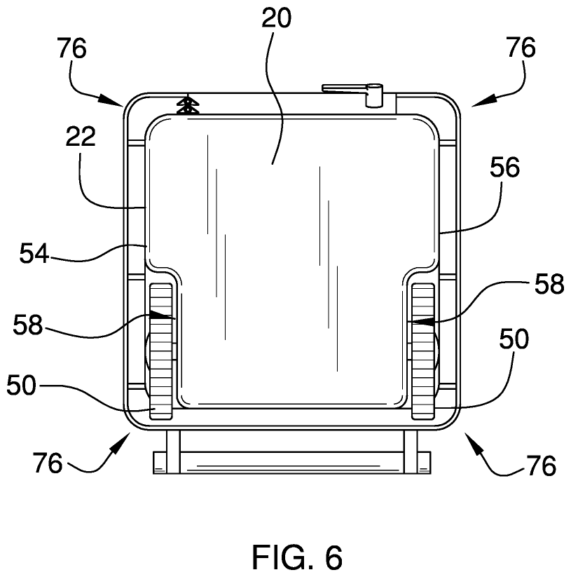

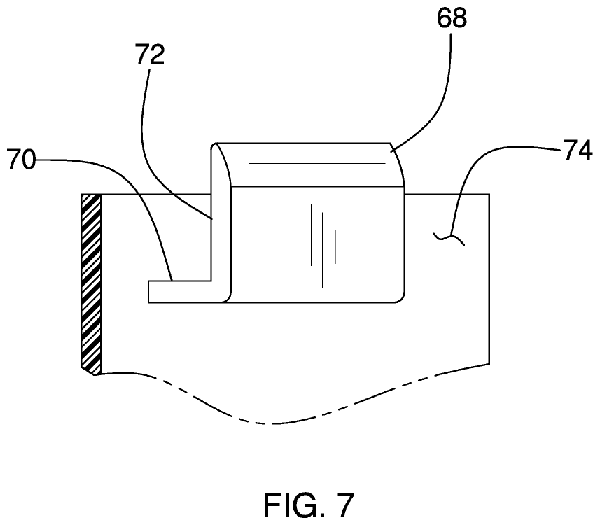

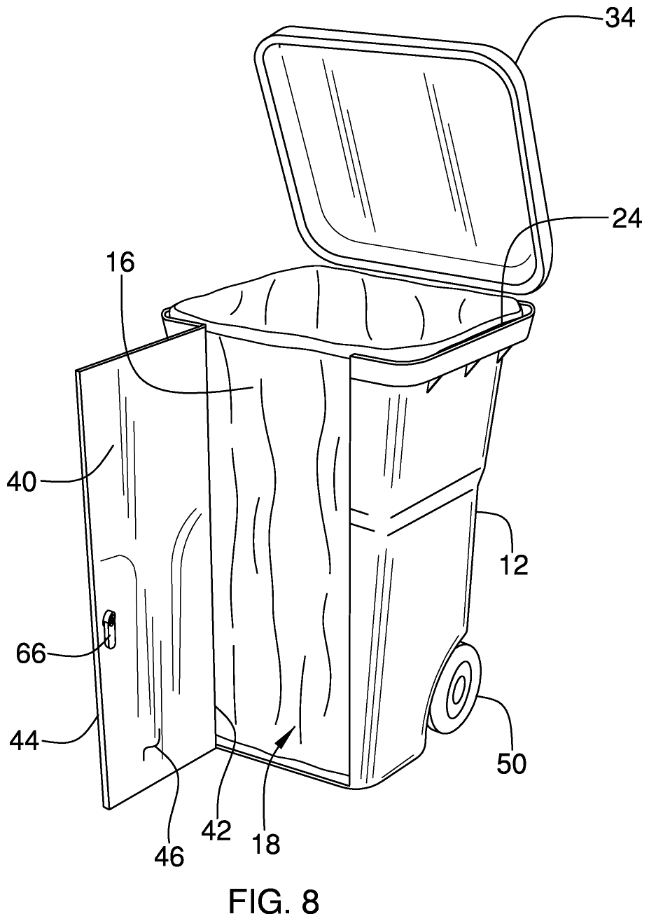

With reference now to the drawings, and in particular to FIGS. 1 through 8 thereof, a new garbage device embodying the principles and concepts of an embodiment of the disclosure and generally designated by the reference numeral 10 will be described.

As best illustrated in FIGS. 1 through 8, the garbage receptacle assembly 10 generally comprises a garbage can 12 that has an open top end 14 to facilitate a garbage bag 16 to be positioned therein. The garbage can 12 has a front entry 18 that is integrated therein to facilitate the garbage bag 16 to be removed through the front entry 18 without requiring the garbage bag 16 to be lifted out of the garbage can 12. The garbage can 12 has a bottom wall 20 and an outer wall 22 extending upwardly therefrom, and the outer wall 22 has a distal edge 24 with respect to the bottom wall 20 to define the open top end 14. The outer wall 22 has a front side 26 and a back side 28, and the front entry 18 extends through the front side 26. The front entry 18 has a first lateral bounding edge 30 and a second lateral bounding edge 32, and the front entry 18 extends between the bottom wall 20 and the distal edge 24 of the outer wall 22.

A lid 34 is provided and the lid 34 is hingedly coupled to the garbage can 12. The lid 34 is positionable in a closed position for closing the open top end 14 and the lid 34 is positionable in an open position for exposing the open top end 14. The lid 34 has a bottom side 36 and a back edge 38, and the back edge 38 is hingedly coupled to the distal edge 24 of the outer wall 22 of the garbage can 12. Additionally, the bottom side 36 rests on the distal edge 24 when the lid 34 is in the closed position.

A door 40 is hingedly coupled to the garbage can 12 and the door 40 is aligned with the front entry 18. The door 40 closes the front entry 18 when the door 40 is in a closed position and the door 40 exposes the front entry 18 when the door 40 is in an open position. The door 40 has a first lateral edge 42, a second lateral edge 44, a back surface 46 and a front surface 48. The first lateral edge 42 is hingedly coupled to the first lateral bounding edge 30 of the front entry 18 and the door 40 extends along a full height of the front entry 18.

A pair of rollers 50 is each rotatably coupled to the garbage can 12 to facilitate the garbage can 12 to be rolled along a support surface 52 for transporting the garbage can 12. Each of the rollers 50 is positioned on a respective one of a first lateral side 54 and a second lateral side 56 of the outer wall 22 of the garbage can 12. Additionally, each of the rollers 50 is aligned with the bottom wall 20 of the garbage can 12. Each of the first lateral side 54 and the second lateral side 56 may have a wheel well 58 being integrated therein and each of the rollers 50 may be positioned in the wheel well 58 in the respective first lateral side 54 and the second lateral side 56.

A closure 60 is provided and the closure 60 is rotatably integrated on the door 40 such that the closure 60 can be manipulated by a user. The closure 60 engages the garbage can 12 when the closure 60 is in a locked position for retaining the door 40 in the closed position. Additionally, the closure 60 disengages the garbage can 12 when the closure 60 is in an unlocked position for facilitating the door 40 to be opened. The closure 60 comprises a handle 62 that is positioned on the front surface 48 of the door 40 and the handle 62 is positioned adjacent to the second lateral edge 44 of the door 40.

The handle 62 extends downwardly along the front surface 48 and the handle 62 includes a shaft 64 that extends through the front surface 48 and the back surface 46 of the door 40. The handle 62 includes a foot 66 that is coupled to the shaft 64 such the foot 66 extends along the back surface 46 of the door 40. The foot 66 engages the second lateral bounding edge 32 of the front entry 18 when the handle 62 is positioned in a first position. Additionally, the foot 66 disengages the second lateral bounding edge 32 when the handle 62 is positioned in a second position.

A plurality of clips 68 is provided and each of the clips 68 is integrated into the garbage can 12. The garbage bag can be suspended from the plurality of clips 68 to retain the garbage bag 16 in an open position while the garbage bag 16 is positioned in the garbage can 12. In this way the plurality of clips 68 enhances placing garbage into the garbage bag 16.

Each of the clips 68 comprises a leg 70 and a foot 72. The leg 70 of each lip is coupled to an inside surface 74 of the outer wall 22 of the garbage can 12. Additionally, the foot 72 of each clip is spaced from the inside surface 74 having the foot extending upwardly from the leg 70. Each of the clips 68 is positioned adjacent to the distal edge 24 of the outer wall 22 of the garbage can 12 and each of the clips 68 is aligned with a respective one of four corners 76 of the outer wall 22. The garbage bag 16 is rolled over the foot 72 of each of the clips for suspending the garbage bag 16 on the clips 68.

In use, the garbage bag 16 is placed in the garbage can 12 and the garbage bag is rolled over the foot 72 of each of the clips 68 for suspending the garbage bag from the clips 68. In this way the garbage bag 16 is retained in an open position to enhance placing garbage in the garbage bag 16. The door 40 is opened to facilitate the garbage bag 16 to be removed from the garbage can 12, through the front entry 18, when the garbage bag 16 is full. In this way the garbage bag 16 does not have to be lifted upwardly out of the garbage can 12 as is required with conventional garbage cans.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A garbage receptacle assembly having a swinging door integrated therein for enhancing removing a garbage bag therefrom, said assembly comprising:
a garbage can having an open top end wherein said open top end is configured to have a garbage bag positioned therein, said garbage can having a front entry being integrated therein wherein said front entry is configured to facilitate the garbage bag to be removed through said front entry without requiring the garbage bag to be lifted out of said garbage can, wherein said garbage can has a bottom wall and an outer wall extending upwardly therefrom, said outer wall having a distal edge with respect to said bottom wall to define said open top end, said outer wall having a front side and a back side, said front entry extending through said front side, said front entry having a first lateral bounding edge and a second lateral bounding edge, said front entry extending between said bottom wall and said distal edge of said outer wall;
a lid being hingedly coupled to said garbage can, said lid being positionable in a closed position for closing said open top end, said lid being positionable in an open position for exposing said open top end;
a door being hingedly coupled to said garbage can, said door being aligned with said front entry, said door closing said front entry when said door is in a closed position, said door exposing said front entry when said door is in an open position;
a pair of rollers, each of said rollers being rotatably coupled to said garbage can wherein said pair of rollers is configured to facilitate said garbage can to be rolled along a support surface for transporting said garbage can;
a closure being rotatably integrated on said door wherein said closure is configured to be manipulated by a user, said closure engaging said garbage can when said closure is in a locked position for retaining said door in said closed position, said closure disengaging said garbage can when said closure is in an unlocked position for facilitating said door to be opened; and
a plurality of clips, each of said clips being integrated into said garbage can wherein each of said clips is configured to engage the garbage bag positioned in said garbage can for retaining the garbage bag in an open position, wherein each of said dips includes a leg and a foot said leg of each clip being coupled to an inside surface of said outer wall of said garbage can, said foot of each clip being spaced from said inside surface having said foot of each said clip extending upwardly from said leg, each of said clips being positioned adjacent to said distal edge of said outer wall of said garbage can such that a distal edge of each said dip relative to said leg extends beyond and above said distal edge of said outer wall, each of said clips being aligned with a respective one of four corners of said outer wall.

2. (canceled)

3. The assembly according to claim 1, wherein said lid has a bottom side and a back edge, said back edge being hingedly coupled to said distal edge of said outer wall of said garbage can, said bottom side resting on said distal edge when said lid is in said closed position.

4. The assembly according to claim 1, wherein said door has a first lateral edge, a second lateral edge, a back surface and a front surface, said first lateral edge being hingedly coupled to said first lateral bounding edge of said front entry, said door extending along a full height of said front entry.

5. The assembly according to claim 2, wherein each of said rollers is positioned on a respective one of a first lateral side and a second lateral side of said outer wall of said garbage can, each of said rollers being aligned with said bottom wall of said garbage can.

6. The assembly according to claim 4, wherein said closure comprises a handle being positioned on said front surface of said door, said handle being positioned adjacent to said second lateral edge of said door, said handle extending downwardly along said front surface, said handle including a shaft extending through said front surface and said back surface of said door.

7. The assembly according to claim 6, wherein said closure includes a foot being coupled to said shaft such said foot of said closure extends along said back surface of said door, said foot of said closure engaging said second lateral bounding edge of said front entry when said handle is positioned in a first position, said foot of said closure disengaging said second lateral bounding edge when said handle is positioned in a second position.

8. (canceled)

9. A garbage receptacle assembly having a swinging door integrated therein for enhancing removing a garbage bag therefrom, said assembly comprising:
a garbage can having an open top end wherein said open top end is configured to have a garbage bag positioned therein, said garbage can having a front entry being integrated therein wherein said front entry is configured to facilitate the garbage bag to be removed through said front entry without requiring the garbage bag to be lifted out of said garbage can, said garbage can having a bottom wall and an outer wall extending upwardly therefrom, said outer wall having a distal edge with respect to said bottom wall to define said open top end, said outer wall having a front side and a back side, said front entry extending through said front side, said front entry having a first lateral bounding edge and a second lateral bounding edge, said front entry extending between said bottom wall and said distal edge of said outer wall;
a lid being hingedly coupled to said garbage can, said lid being positionable in a closed position for closing said open top end, said lid being positionable in an open position for exposing said open top end, said lid having a bottom side and a back edge, said back edge being hingedly coupled to said distal edge of said outer wall of said garbage can, said bottom side resting on said distal edge when said lid is in said closed position;
a door being hingedly coupled to said garbage can, said door being aligned with said front entry, said door closing said front entry when said door is in a closed position, said door exposing said front entry when said door is in an open position, said door having a first lateral edge, a second lateral edge, a back surface and a front surface, said first lateral edge being hingedly coupled to said first lateral bounding edge of said front entry, said door extending along a full height of said front entry;
a pair of rollers, each of said rollers being rotatably coupled to said garbage can wherein said pair of rollers is configured to facilitate said garbage can to be rolled along a support surface for transporting said garbage can, each of said rollers being positioned on a respective one of a first lateral side and a second lateral side of said outer wall of said garbage can, each of said rollers being aligned with said bottom wall of said garbage can;
a closure being rotatably integrated on said door wherein said closure is configured to be manipulated by a user, said closure engaging said garbage can when said closure is in a locked position for retaining said door in said closed position, said closure disengaging said garbage can when said closure is in an unlocked position for facilitating said door to be opened, said closure comprising:
a handle being positioned on said front surface of said door, said handle being positioned adjacent to said second lateral edge of said door, said handle extending downwardly along said front surface, said handle including a shaft extending through said front surface and said back surface of said door; and
a foot being coupled to said shaft such said foot of said closure extends along said back surface of said door, said foot of said closure engaging said second lateral bounding edge of said front entry when said handle is positioned in a first position, said foot of said closure disengaging said second lateral bounding edge when said handle is positioned in a second position; and
a plurality of clips, each of said clips being integrated into said garbage can wherein each of said clips is configured to engage the garbage bag positioned in said garbage can for retaining the garbage bag in an open position, each of said clips including a leg and a foot, said leg of each clip being coupled to an inside surface of said outer wall of said garbage can, said foot of each clip being spaced from said inside surface having said foot extending upwardly from said leg, each of said clips being positioned adjacent to said distal edge of said outer wall of said garbage can such that a distal edge of each said clip relative to said leg extends beyond and above said distal edge of said outer wall, each of said clips being aligned with a respective one of four corners of said outer wall.
